(19) United States
(12) Patent Application Publication
(10) Pub. No.: US 2003/0169550 A1
(43) Pub. Date: Sep. 11, 2003

(54) Circuit arrangement with a circut breaker

(76) Inventor: Richard Burk, Hochdorf (DE)

Correspondence Address: Baker & Daniels, Suite 800, 111 East Wayne Street, Fort Wayne, ID, 46802, US

(21) Appl. No.: 10/296,334

(22) PCT Filed: May 21, 2001
(86) PCT No.: PCT/EP01/05948

(30) Foreign Application Priority Data
May 26, 2000 (DE) 10025908.1

(51) Int. Cl. H02H 3/20

(52) U.S. Cl. 361/91.2

(57) ABSTRACT

The invention relates to an electronic circuit arrangement comprising a circuit breaker. The circuit breaker comprises an on-off switch; a first interface; a voltage divider; a connection for an external voltage supply; a ground connection. The interface is connected in a flexible manner in the form of an input and output for detecting a state. The circuit breaker comprises a second interface which is used to connect an evaluation and/or diagnostic unit.

The invention concerns an electronic circuit arrangement comprising a circuit breaker, a control device, and an evaluation or diagnosis procedure with such a circuit arrangement or with such a control device.

Circuit arrangements with a circuit breaker are used in electronic control devices, for example, motor control devices or transmission control devices and are able to realize digital power outputs, for which it is possible to simultaneously diagnose certain conditions.

Infineon, for example, offers an intelligent power semi-conductor “Smart High-Side Power Switch BTS 723G” for control circuits that represents a switch through the monolithically integrated combination switching of a circuit and a power semi-conductor and that is simultaneously in the position to take over drive, protective, and monitoring functions. This power semi-conductor comprises a complicated architecture with fields of resistors and diodes and an internal voltage source. The module can only be switched as an output, the control must take place via special interfaces through CMOS circuits. There are different logic channels brought into the module that link the external control signals with internal signals and then generate the control signals for a power field-effect transistor—Power-MOSFET and status signals.

A disadvantage on the circuit arrangements with these known circuit breakers, which have a switch as well as a diagnostics function, is for one the complicated construction, in particular the circuit breaker and the limitation that it can only be used as a pure exist. Moreover, the known circuit breakers in the circuit arrangements are inflexible with respect to their diagnostics function, since the diagnosed statuses are separated into tight grids, whose limit values cannot be changed and thus restrict the applicability of the circuit arrangement in different systems.

The disadvantage of recognized control devices is that they must be designed, in particular due to their circuit arrangements, with inflexible circuit breakers for the corresponding field of use. Therefore, for example, control devices that can be used for capturing the status of an electric component are available, such as for example, a switch or a sensor, i.e., that can be used or switched exclusively as an input. These recognized control devices also have the disadvantage that their response thresholds or levels are permanently set by the hardware used. The control devices of the other type that exists can only handle control functions, which means that they can only be used as an output or as a power output.

Due to these many different types of control devices, the contract completion costs and especially the production and warehouse costs as well as the cost of logistics are high.

It is thus the purpose of this invention to avoid the outlined disadvantages of the current technical state and provide a control device, the production of which can be greatly standardized with respect to control devices of the current state. In particular, a control device should be provided that can be used universally and that has hardware that is flexible enough to be used as an input and as an output.

Furthermore, it is the purpose of this invention to create a circuit arrangement with a circuit breaker that is characterized by a simple construction, that can be used as an input and an output and that enables the recognition or the diagnosis of all statuses whereby the registration and evaluation are flexible. A procedure for diagnosing the status of an electronic switch with such an electronic circuit arrangement or with such a control device is also to be presented.

This purpose is fulfilled by a circuit arrangement with the characteristics of claim 1, by a control device with the characteristics of claim 18, and by a procedure with the characteristics of claim 33. Additional advantages of the invention are included in the sub-claims.

The control device comprises an on/off switch that, in particular, can be used as a relay or a semi-conductor switch, e.g., Power-MOSFET or transistor, a connection for an external voltage supply and a ground connection. Based on the invention, the control device also comprises two interfaces, whereby a first interface is switched to be an input or output. Thus, based on the desired use of the control device, the same hardware can either be used for recognition of an external input signal or level or for diagnosis—by switching the first interface to input mode—or for power control—by switching of the first interface as an output. Even when the first interface is set as an output, a diagnosis of the status is possible at the first interface, e.g., whether the switching is interrupted, a short circuit is present or a user is connected against ground or a voltage supply. The second interface serves as a connection of an evaluation or diagnosis unit and this enables an extremely flexible evaluation of the captured data/conditions. Moreover, the control device comprises a voltage divider that can advantageously be executed through two Ohmic resistors. The voltage divider enables the setting of a level of the first interface of the control device. Since the control device and thus also the voltage divider are connected to an external voltage supply, the level depends on the external voltage.

Of course, it is possible to arrange several groups of these circuit arrangements in one control device in order to receive several interfaces.

In a special version of the invention, a second voltage divider, which serves to adjust the voltage especially to the following analysis unit, is connected in front of the second interface. This is particularly advantageous if an analysis unit, whose input is designed for lower voltages, is attached to the second interface. For attenuating the oscillations of the voltage adjacent to the second interface, a smoothing filter can be connected before the second interface.

In a special version of the invention, the voltage divider is executed through two Ohmic resistors. By selecting the resistor size, the level of the circuit breaker, i.e., for the first interface, can be set. Luckily, two equal Ohmic resistors can be connected so that the level is 50% of the supply voltage.

It can also be advantageous in another version of the invention to execute the voltage divider with a different level, for example, by connecting two different Ohmic resistors or a variable voltage divider. This is particularly advantageous when, for example, another external device, the recording range of which functions in a certain voltage band, is connected to the first interface. In this manner, the level of the first interface can be shifted in order to prevent the input wiring of the external control device from already being contacted by the level. A version with different Ohmic resistors for shifting the level in the direction of the mass is particularly advantageous when using the on/off switch as a high-side switch. When using a low-side switch, the shift of the level in the direction of the voltage of the voltage supply, which can amount to 24 Volts, is particularly advantageous.

In accordance with the invention, the control device comprises an on/off switch, which is a low-side switch in a particular version. This is particularly advantageous when a load is switched against the voltage supply. In another version of the invention, the on/off switch is a high-side switch; this is particularly advantageous when a load is switched against ground.

Moreover, the invention comprises an electronic circuit arrangement with a circuit breaker, which comprises the same characteristics as the control device named in the invention.

It is particularly advantageous that an analog-digital converter can be connected behind the second interface. In a more advanced version of the invention, a computer is also connected behind the second interface. Thus, for example, it is possible to connect the analog input of the analog-digital converter directly to the second interface and the digital input of the output of the analog-digital converter to the computer. Of course, it is also possible to connect a computer directly behind or to the second interface. A voltage divider or a smoothing filter can also be connected behind the second interface, the advantage being a lower voltage amplitude or lower oscillation in the voltage, which is fed on to the subsequent analysis/diagnostics unit. The advantage of the named circuit arrangements with an arrangement of a circuit breaker and an analysis or diagnostics unit based on the invention is, above all, the great flexibility during the evaluation of the conditions.

In a particular version of the invention, the electronic circuit arrangement comprises a device that is connected to the first interface. In this case, the circuit breaker functions as the output. The diagnosis of the states of the consumer or the circuit arrangement itself is possible.

In another version of the invention, the interface is set as the input, and the on/off switch remains deactivated. An external switch is then advantageously connected between the first interface and the voltage supply, or, in other version, an external switch is connected between the interface and the ground. Signals from external encoders can thus be captured.

It is particularly advantageous that an input can be made as needed from an output using software and thereby, for example, with integration in a control device of the circuit arrangement based on the invention, the control device is much more flexible. Thus, the same circuit arrangement or the same control device can be used for power control and for diagnosing the status of an electronic device or for the evaluation of external switch elements, sensors or encoders. Appropriately, the circuit arrangement or the control device is inserted into an external switch/external circuit arrangement.

Furthermore, the invention comprises a procedure for evaluating or diagnosing the status of an electronic switch with an electronic circuit arrangement based on the invention or a control device based on the invention. Based on the invention, the voltage adjacent to the second interface is determined with an analysis/diagnostics unit that is attached to the second interface. It is particularly advantageous that the analysis unit or the diagnostics unit comprises an analog/digital converter with computer turned on later or a computer with such an interface. The procedure thus determines whether the first interface is set as an output or input, i.e., whether the interface of the control device/circuit arrangement will be used as an output for power control or as an input for determining the status of an external switch element/sensor.

A further input size of the evaluation procedure is the placement of the on/off switch. In a more advanced version of the procedure named in the invention, the voltage determined at the second interface is compared with a voltage band, which is divided into voltage areas. It is particularly advantageous that the reference voltage band can thus be deposited in the analysis/diagnostics unit, especially the boundaries of the voltage bands, for example, by programming the computer. In this manner, it is possible to maintain a flexible reference voltage band; in particular, the boundaries of the voltage bands can be adjusted based on current demands.

The procedure based on the invention takes into consideration different input sizes during the evaluation of the status of an electronic switch. This includes the distinction whether the first interface is set as the input or output, whether the on/off switch is a high- or low-side switch, and, in a more advanced version, whether the on/off switch is open or closed.

First, a level for an open interface is adjusted with a voltage divider. This can take place in particular, through selection of the corresponding Ohmic resistors. However, based on the invention, a voltage divider that maintains a variable level setting is also conceivable. Luckily, the voltage of the voltage supply and/or the voltage level of the level can be measured in order to receive an exact reference for later comparison. If the interface is set as the output and the on/off switch is a high-side switch that is open, then the procedure named in the invention distinguishes between four different statuses of the electronic circuit arrangement based on voltage determined at the second interface. This then means that the reference band in the analysis unit and, in particular, the computer is divided into four separate bands. It is advantageous that a hysteresis, which prevents constant switching in the boarder area, is implemented in the transition area between the individual bands. Of course, in terms of the invention, it is also possible to subdivide the voltage band into a different number of bands. When taking into consideration a low-side switch, it would, for example, be advantageous to introduce a fifth band. The four different statuses of the electronic circuit arrangement named that can be diagnosed based on the voltage determined in the second interface are as follows:

a) if the determined voltage in a voltage band lies at the no-load level, the circuit is interrupted at the interface, or there is no load attached;

b) if the determined voltage in a voltage band lies near 0 volts, then there is a short circuit present against ground at the interface;

c) if the determined voltage in a voltage band lies below the voltage band of the no-load level and above the voltage band near 0 volts, then there is a load against ground at the interface;

d) if the determined voltage in a voltage band lies near the voltage of the voltage supply, then there is a short circuit against the voltage supply.

If the high-side switch is now on, there are three statuses possible based on the invention:

a) if the determined voltage in a voltage band moves near the voltage of the voltage supply, then the circuit arrangement operates error free;

b) if the determined voltage in a voltage band lies within the no-load range, then there is a general error in the circuit arrangement, i.e. a short circuit against an external background noise or a defective on/off switch;

c) if the determined voltage in a voltage band lies near 0 volts, then there is a short circuit present against ground at the interface.

If the interface is switched as an input, the on/off switch a high-side switch and open, then three different statuses of the electronic circuit arrangement possible based on the invention via the voltage determined in the second interface:

a) if the determined voltage in a voltage band lies at the no-load level, then the circuit is interrupted at the interface, i.e. through an open, external switch;

b) if the determined voltage in a voltage band lies near the voltage of the voltage supply, the external switch is closed against the voltage supply;

c) if the determined voltage in a voltage band lies near 0 volts, the external switch is closed against ground.

Recognition of the status is thereby not restricted to an external switch; i.e., states and levels from external encoders or sensors can be identified as well.

When switching the on/off switch as low-side switch, it must also be determined whether the interface is switched to input or output, and whether the low-side switch is open or closed. If the interface is switched to output and the low-side switch is open, then a determination can be made between four different statuses of the electronic circuit arrangement by means of the determined voltage:

a) if the determined voltage in a voltage band lies at the no-load level, then the circuit is interrupted at the interface, or there is no load attached;

b) if the determined voltage in a voltage band lies near 0 volts, then there is a short circuit against ground at the interface;

c) if the determined voltage in a voltage band lies near the voltage of the voltage supply, then there is a short circuit against the voltage supply;

d) if the determined voltage in a voltage band lies above the voltage band at the no-load level and below the voltage band near the voltage of the voltage supply, then there is a load against the voltage supply at the interface.

If the low-side switch is now closed, then three different statuses of the electronic circuit arrangement can be recognized by means of the determined voltage at the second interface:

a) if the determined voltage in a voltage band moves near 0 volts, then the circuit arrangement operates error free;

b) if the determined voltage in a voltage band lies at the no-load level, then there is a general error in the circuit arrangement, i.e., a short circuit against an external background noise or a defective on/off switch;

c) if the determined voltage in an voltage band lies near the voltage of the voltage supply, then there is a short circuit against the voltage supply at the interface.

If, however, the interface is switched as an input and the low-side switch is open, then a determination can be made between three different statuses of the electronic circuit arrangement by means of the voltage at the second interface:

a) if the determined voltage in a voltage band lies at the no-load level, then the circuit is interrupted at the interface, i.e., by an open, external switch;

b) if the determined voltage in a voltage band lies near the voltage of the voltage supply, then the external switch is closed against the voltage supply;

c) if the determined voltage in a voltage band lies near 0 volts, then the external switch is closed against ground.

Of course, based on the invention, it is also possible to include additional input parameters in the evaluation or diagnosis. It is then conceivable that additional switches or relays are included in the circuit arrangement; these can also lie within the circuit breaker as well as outside the same; the number of voltage bands can then be adjusted based on the invention. In particular, the variable determination of the limits of the individual voltage bands restricts the diagnosis of a circuit arrangement expanded with additional devices, and favorably enables the recognition of different conditions.

The incorrect or an at-risk component, e.g., the on/off switch, can be favorably deactivated to prevent further damage upon recognition of an error by the device or procedure based on the invention. Warning signals can be given instead or even in addition to, e.g., optical or acoustical signals, as well as error entries made in the error memory, e.g., a control device.

The circuit breaker can be in an electronic circuit arrangement, and obviously also be integrated in other devices, e.g., integration in a gear control device.

Under an additional aspect of the invention it is conceivable that the high-side switch as well as the low-side switch are integrated in the circuit breaker of the circuit arrangement or control device, which is alternatively controllable via a computer.

The invention is explained further by means of design examples. They show:

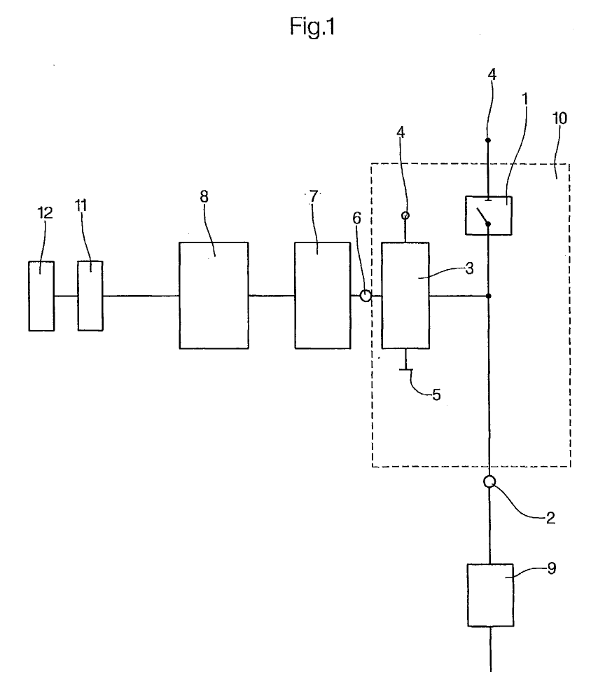

FIG. 1 a circuit arrangement based on the invention using the first interface as an output;

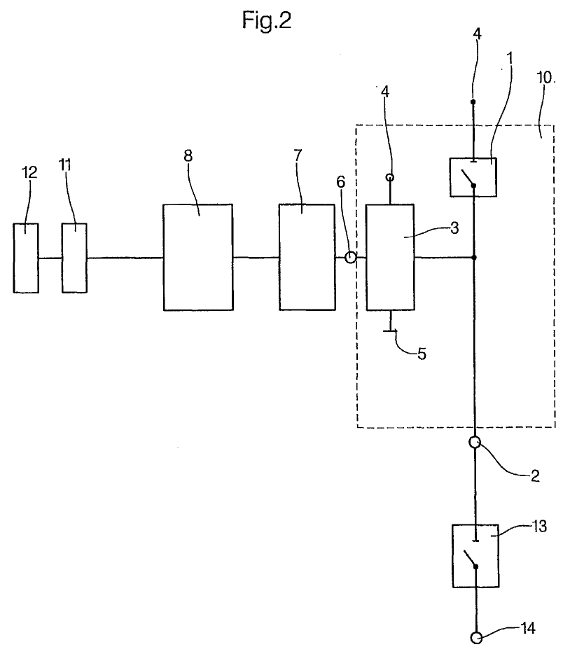

FIG. 2 a circuit arrangement based on the invention using the first interface as an input and an external switch switched between the voltage supply and the interface;

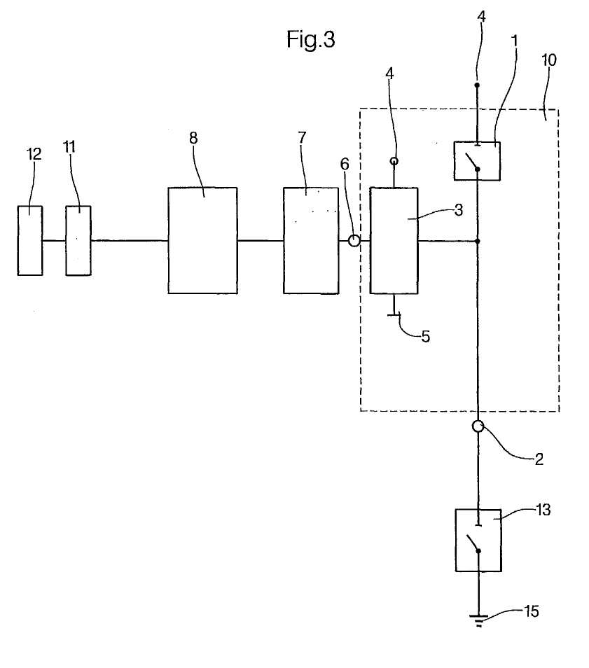

FIG. 3 a circuit arrangement based on the invention using the first interface as an input and an external switch switched between the interface and ground;

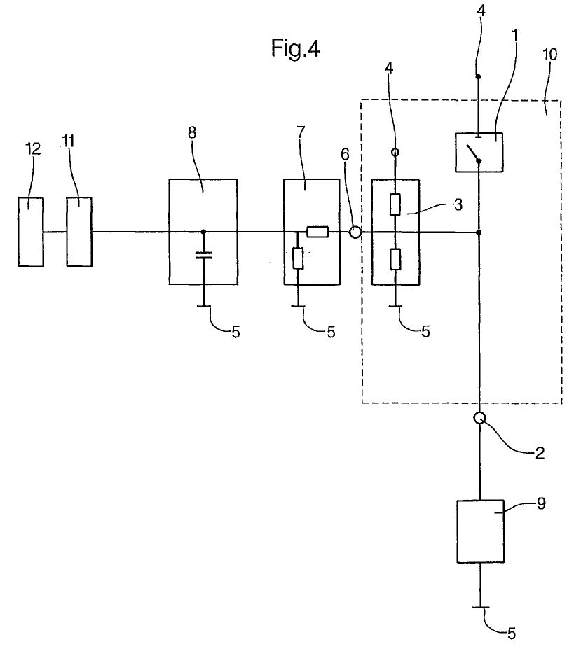

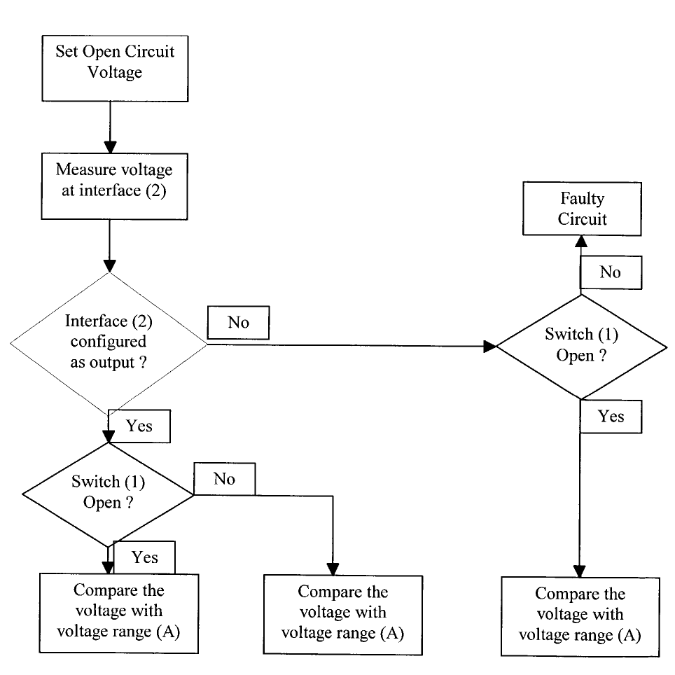

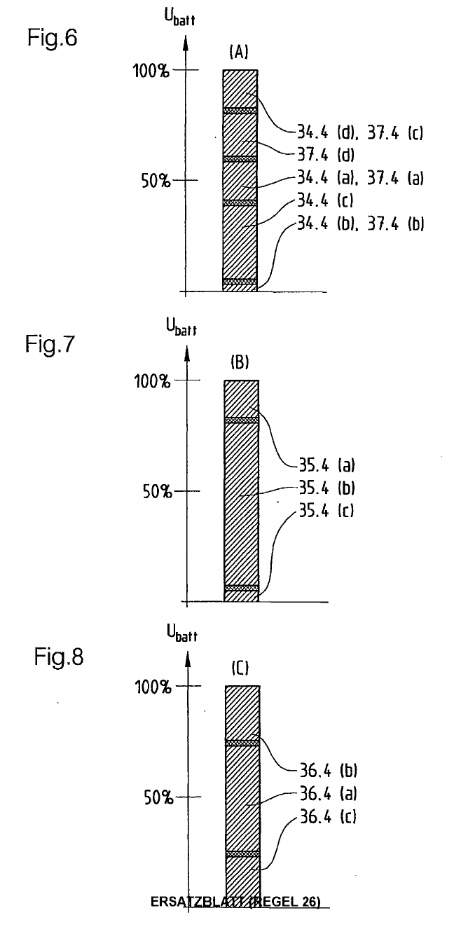

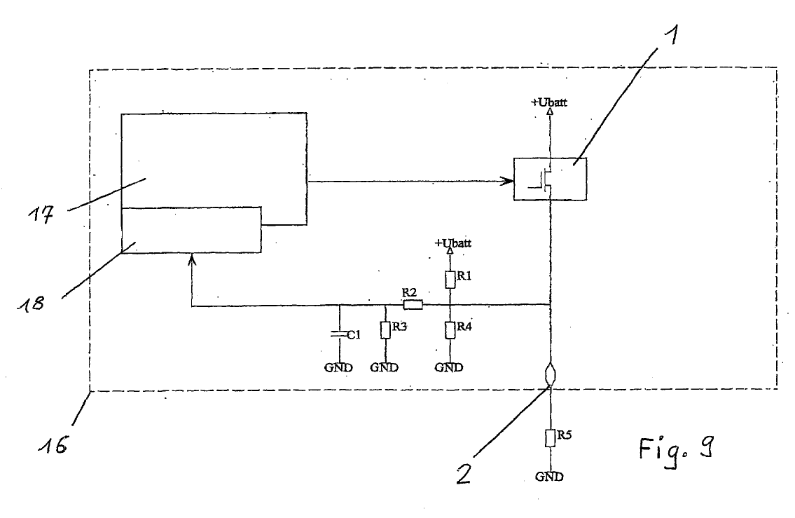

FIG. 4 a circuit arrangement based on the invention with an execution of the voltage divider with ohmic resistance;

FIG. 5 a flow chart of the procedure based on the invention with an on/off switch as a high-side switch;

FIG. 6 a voltage band when using the first interface as an output and open on/off switch;

FIG. 7 a voltage band when using the first interface as an output and closed high-side switch;

FIG. 8 a voltage band when using the first interface as an input and open on/off switch;

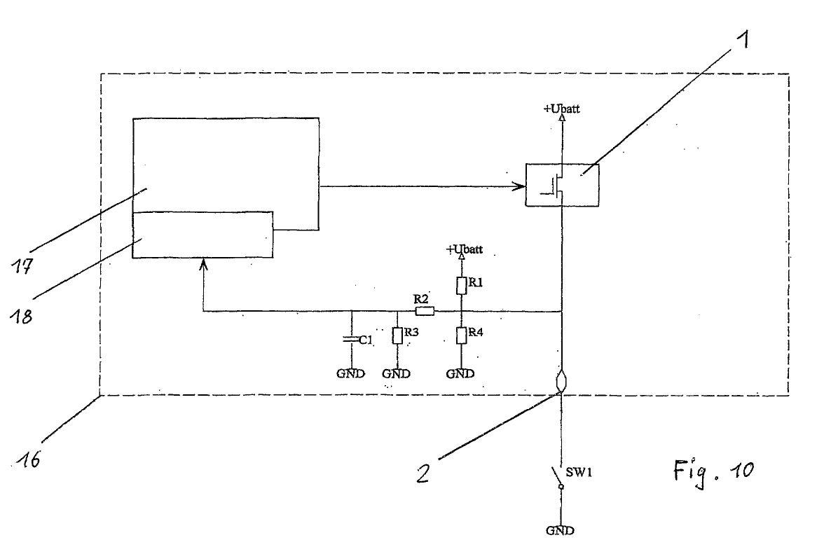

FIG. 9 a control device based on the invention using the first interface as an output for controlling a device;

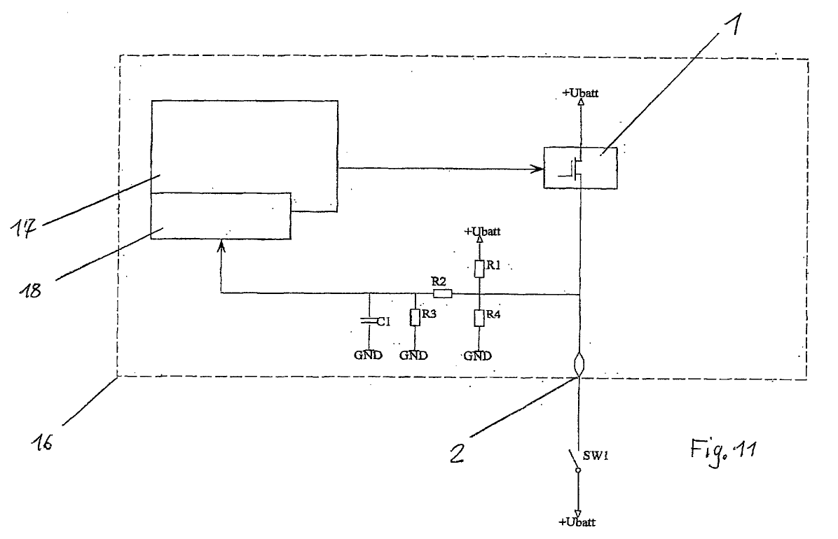

FIG. 10 a control device based on the invention using the first interface as an input for evaluating the status of an external low-side switch.

FIG. 11 a control device based on the invention using the first interface as an input for evaluating the status of an external high-side switch.

FIG. 1 represents a circuit arrangement with a circuit breaker 10. The circuit breaker 10 includes an on/off switch 1, which here is a high-side switch since it is linked with an adaptor for a voltage supply 4. Further, one recognizes interface 2 (first), on which a load bus 9 is switched. A voltage divider 3 includes a connection for a voltage supply 4 and a ground connection 5 and is switched in the representation before a second interface 6. Behind the second interface 6 there is a second voltage divider 7 that can also be switched before the second interface 6. Behind the second voltage divider 7 a smoothing filter 8 is utilized. This smoothing filter 8 can also be integrated before the second interface 6. Behind the smoothing filter 8 is an AD converter 11 that is again connected to a computer 12. AD converter 11 and computer 12 are intended as the evaluation/diagnosis units. It is also conceivable that the computer 12 is attached directly to the second interface 8, if it is available via a respective input. Since a load bus 9 is run to interface 2 in the represented circuit arrangement, interface 2 is used as an output in this case.

FIG. 2 represents a circuit arrangement based on the invention with the switching using interface 2 as an input. The construction of circuit breaker 10 and the circuit string before or behind interface 6 is not different than the circuit arrangement from FIG. 1. The same elements have the same reference symbols. An external switch 13 is switched between interface 2 and voltage supply 14.

FIG. 3 represents an additional circuit arrangement using interface 2 as an input. Again, the setup of the circuit breaker 10 and the switch string before or behind the interface 6 does not differentiate itself from the circuit arrangement in FIG. 1. The same elements have the same reference symbols. An external switch 13 is switched between interface 2 and voltage supply 14.

FIG. 3 represents an additional circuit arrangement using interface 2 as an input. Again, the setup of the circuit breaker 10 and the string before or behind the second interface 6 does not differentiate itself from FIG. 1 and FIG. 2. Based on the invention, an external switch 13 is integrated between the interface 2 and ground 15 in this example.

FIG. 4 shows a particular circuit arrangement based on the invention when using the voltage divider with the interconnection of ohmic resistors. The voltage divider 3 is run against the ground connection by switching an ohmic resistor against the connection to the voltage supply 4 and another ohmic resistor that can have the same size based on the invention. The second voltage divider 7 is executed by switching an ohmic resistor against the second interface 6 and an ohmic resistor against a ground connection 5. To its advantage, as represented, the smoothing filter 8 is executed with a condenser switched against the ground connection 5. The interface 2 is used thereby as an output. A load bus 9 is switched between the ground connection 5 and the interface 2.

FIG. 5 represents a flow chart of the procedure based on the invention. The no-load level is first set. This can be performed by the selected execution of the voltage divider 3. The targeted setting of the no-load level via, for example, adjustable resistances is conceivable. The voltage at the interface 2 is set dependent on the enclosed voltage of the voltage supply and the enclosed load. A step in measuring the voltage of the voltage supply and/or the voltage level of the no-load level can be favorably included in order to have an exact reference value for the resulting comparison; it is, however, not represented in the execution of the procedure based on the invention as described in FIG. 5.

As a result, the voltage at interface 2 determines, for example via the voltage at the interface 6, and then by means of the statuses of interface 2 and the switch 1 decides, with which voltage band the voltage enclosed at interface 2 must be compared. If interface 2 is thereby used as an input, then it should be noted that there is no damage to the components of the circuit arrangement or in particular the external components, e.g. switches, sensing elements or sensors. This can be assured, for example, in that switch 1 may not be closed.

FIG. 6 represents a voltage band, with which the voltage determined at the interface 2 can be compared, if the interface 2 is switched as an output and the on/off switch 1 is open. If the on/off switch 1 is a high-side switch, then the four areas 34.4 (a) to 34.4 (d) result as purposeful voltage bands, with which the voltage determined at interface 2 can be compared. Ubatt is thereby the voltage of the voltage supply that flows in as reference value in the voltage bands. If the on/off switch 1 is a low-side switch, the voltage band 37.4 (d) should be used in place of the voltage band 34.4 (c). The meaning of the voltage bands can be taken from claims 3 8.4 or 41.4.

FIG. 7 represents a voltage band for comparison with the voltage enclosed at the interface 2, if the interface is switched as an output and the switch 1 is closed. The meaning of the individual voltage bands can be taken from claim 39.4.

FIG. 8 represents a voltage band for comparison with the voltage determined at the interface 2 when interface 2 is switched input and on/off switch 1 open. The meaning of the voltage bands can be taking from claim 40.

FIG. 9 represents a control device 16 based on the invention, with which interface 2 is used as an output. The control device 16 includes a high-side switch 1, e.g. PROFET, transistor or relay that is switched against the external voltage+Ubatt. The opening and closing, for example, of the on/off switches of this switch 1 is controlled by a micro-controller 17. The micro-controller 17 includes the voltage enclosed at the interface 2. There are voltage dividers—including resistances R1 to R4—between micro-controller 17 and interface 2, and a smoothing filter with a condenser C1. Voltage dividers and smoothing filter represent an applied voltage level, which is entered to an AD converter switched before entry of micro-controller 17 and/or comparator 18. The voltage dividers and the smoothing filter are thereby switched to according to the voltage divider 4, 7 and smoothing filter 8 from FIG. 4 between +Ubatt and the ground GND.

An external load (load bus) is switched between the interface 2 and ground GND, which is represented here as resistance R5. This load bus is controlled by means of control device 16, i.e. a given power of the load bus is configured by means of control device 16.

FIG. 10 shows the same control device 16, which is used this time for recording or evaluation of the status of the external low-side switch SW1. For this, interface 2 as the input. The low-side switch SW1 is connected between interface 2 and GND. Using the voltage detected with interface 2, with voltage divider, attenuation filter, AD converter and/or comparator 18 and micro-controller 17, the status of the switch SW1 can be determined. The internal high-side switch 1 remains turned off during the recording or evaluation, i.e., it stays open.

FIG. 11 shows the similarly constructed control device 16 using interface 2 as an input for recording or evaluation of the status of the external high-side switch SW1. The high-side switch SW1 is connected between interface 2 and +Ubatt. Using the voltage from interface 2, its status can be determined. Also in this case, the internal high-side switch 1 remains turned off.

Reference Item List

1 On/Off Switch

2 Interface

3 Voltage Divider

4 Connection for Power Supply

5 Earth (Ground) Connection

6 Second Interface

7 Second Voltage Divider

8 Attenuation Filter

9 Consumer

10 Circuit Breaker

11 Analog-Digital Converter/Comparator

12 Computer/Micro-controller

13 External Switch

14 Power Supply

15 Earth (Ground)

16 Control Device

17 Computer/Micro-controller

18 AD Converter/Comparator

1. Electronic circuit arrangement
1.1 with a circuit breaker (10); the circuit breaker (10) includes
1.2.1 an on/off switch (1)
1.2.2 the first interface (2)
1.2.3 a voltage divider (3)
1.2.4 a connection for an external voltage supply (4)
1.2.5 an earth connection (5)
1.3 The interface (2) is so flexible that it is both an input for the status evaluation as well as an output to the power control.
1.4 The circuit breaker includes a second interface (6) for connecting an evaluation or diagnosis unit.

2. Electronic circuit arrangement according to claim 1 which is defined such that the circuit arrangement contains no internal voltage supplies.

3. Electronic circuit arrangement according to claim 1 or 2 which is defined such that the second interface (6) has its own (a second) voltage divider (7) to divide the voltage on the second interface (6).

4. Electronic circuit arrangement according to claims 1 to 3 which is defined such that there is an attenuation filter, specifically a capacitor (8), connected in front of the second interface (6). This is to dampen the oscillations on the voltage on the second interface (6).

5. Electronic circuit arrangement according to claims 1 to 4 which is defined such that the on/off switch (1) is a relay.

6. Electronic circuit arrangement according to claims 1 to 5 which is defined such that the on/off switch (1) is a semiconductor switch.

7. Electronic circuit arrangement according to claims 1 to 6 which is defined such that the voltage divider (3) is variable.

8. Electronic circuit arrangement according to claims 1 to 7 which is defined such that the on/off switch (1) is a high side switch.

9. Electronic circuit arrangement according to claims 1 to 7 which is defined such that the on/off switch (1) is a low side switch.

10. Electronic circuit arrangement according to claims 1 to 9 which is defined such that there is an analog-digital converter (1) connected after the second interface (6).

11. Electronic circuit arrangement according to claim 10 which is defined such that there is a computer (12) connected to the digital output of the analog-digital converter.

12. Electronic circuit arrangement according to claims 1 to 11 which is defined such that
12.1 the interface (2) is configured as an output, and
12.2 a consumer (9) is connected to the interface (2)

13. Electronic circuit arrangement according to claims 1 to 11 which is defined such that
13.1 the interface (2) is configured as an input
13.2 an external switch (13) is connected between the interface (2) and a voltage supply (14)

14 Electronic circuit arrangement according to claims 1 to 11 which is defined such that
14.1 the interface (2) is configured as an input,
14.2 an external switch (13) is connected between the interface (2) and ground (15)

15 Electronic circuit arrangement according to claims 1 to 14 which is defined such that the circuit breaker (10) is an separate individual component.

16 Electronic circuit arrangement according to claims 1 to 14 which is defined such that the circuit breaker (10) is integrated into another component on the circuit arrangement.

17 Electronic circuit arrangement according to claims 1 to 14 which is defined such that the circuit breaker (10) is integrated in a control device, especially a gear control device.

18 Electronic control device, especially a gear control device includes:
18.1 an on/off switch (1)
18.2 a first interface (2)
18.3 a voltage divider (3)
18.4 a connection for an external voltage supply (4)
18.5 an earth connection (5)
18.6 a second interface (6) for connecting an evaluation or diagnosis unit.
18.7 The interface (2) is so flexible that is used for both a status evaluation as well as an output for a power controller.

19 Control device according to claim 18 which is defined such that the control device includes a micro-controller (17) to control the on/off switch (1) whereby an input of the micro-controller (17) is at least indirectly coupled to the second interface (6)

20 Control device according to claims 18 to 19 which is defined such that the control device contains no internal voltage supplies.

21 Control device according to claims 18 to 20 which is defined such that a second voltage divider (7) is connected in front of the second interface (6) to divide the voltage on the second interface (6).

22 Control device according to claims 18 to 21 which is defined such that there is an attenuation filter, specifically a capacitor (8), connected in front of the second interface (6). This is to dampen the oscillations on the voltage on the second interface (6).

23 Control device according to claims 18 to 22 which is defined such that the on/off switch (1) is a relay.

24 Control device according to claims 18 to 22 which is defined such that the on/off switch (1) is a semiconductor switch.

25 Control device according to claim 24 which is defined such that the semiconductor switch is a power MOSFET.

26 Control device according to claim 24 which is defined such that the semiconductor switch is a transistor.

27 Control device according to claims 18 to 26 which is defined such that the voltage divider (3) is configured so that it divides the supplied voltage in half.

28 Control device according to claims 18 to 26 which is defined such that the voltage divider (3) is configured that the created voltage is between half of the output voltage and the output voltage.

29 Control device according to claims 18 to 26 which is defined such that the voltage divider (3) is configured that the created voltage is between zero and half of the output voltage.

30 Control device according to claims 18 to 26 which is defined such that the voltage divider (3) is variable.

31 Control device according to claims 18 to 30 which is defined such that the on/off switch (1) is a high side switch.

32 Control device according to claims 18 to 30 which is defined such that the on/off switch (1) is a low side switch.

33 Procedure to record the status of an electronic circuit with an electronic circuit arrangement according to one of the claims 1 to 17 or a controller according to the claims 18 to 32:
33.1 first the open circuit voltage is set on the open interface (2) with the voltage divider (3)
33.2 then the voltage on the second interface (6) is measured with an evaluation or diagnosis unit connected to the second interface (6)
33.3 depending on the use of the interface (2), as an input or output, and the position of the on/off switch; the status of the electronic circuit is diagnosed using the voltage recorded.

34 Procedure according to claim 33 which is defined such that the evaluation or diagnosis unit contains an analog-digital converter (11) and a computer (12)

35 Procedure according to claims 33 to 34 is defined such that the voltage measured at the second interface (6) is compared to voltage ranges. The allows the status of the electronic circuit to be determined.

36 Procedure according to claim 35 which is defined such that the limits of the voltage ranges overlap.

37 Procedure according to claims 35 to 36 which is defined such that the limits of the voltage ranges can be changed by programming the evaluation or diagnosis or especially the computer (12).

38 Procedure according to claims 33 to 37 which is defined by the following characteristics:
38.1 the interface (2) is configured as an output
38.2 the on/off switch (1) is a high side switch
38.3 the on/off switch (1) is open
38.4 using the voltage measured at the second interface (6), four different statuses of the electronic circuit can be determined:
(a) the measured voltage is in a range around the open circuit voltage, the circuit at the interface (2) is interrupted or there is no load connected (34.4(a))
(b) the measured voltage is in a range near the 0 volt mark, there is a short circuit to ground from the interface (2) (34.4 (b))
(c) the measured voltage is in the range above the near 0 range and below the around the open circuit voltage range, there is a load on the interface (2) (34.4(c))
(d) the measured voltage is in the range near the power supply voltage, there is a short circuit to the power supply (34.4(d))

39 Procedure according to claims 33 to 37 which is defined by the following characteristics:
39.1 the interface (2) is configured as an output
39.2 the on/off switch (1) is a high side switch
39.3 the on/off switch (1) is closed
39.4 using the voltage measured at the second interface (6), four different statuses of the electronic circuit can be determined:
(a) the measured voltage is in a range near the voltage of the power supply, the circuit is working properly (35.4(a))
(b) the measured voltage is in a range around the open circuit voltage, there is a fault in the circuit, especially there is a short circuit to an external voltage or a defective on/off switch (1) (35.4(b))
(c) the measured voltage is in a range near the 0 volt mark, there is a short circuit to ground from the interface (2) (35.4 (c))

40 Procedure according to claims 33 to 37 which is defined by the following characteristics:
40.1 the interface (2) is configured as an input
40.2 the on/off switch (1) is a high side switch
40.3 the on/off switch (1) is open
40.4 using the voltage measured at the second interface (6), four different statuses of the electronic circuit can be determined:
(a) the measured voltage is in a range around the open circuit voltage, the circuit at the interface (2) is interrupted especially through an external open switch (36.4(a))
(b) the measured voltage is in the range near the power supply voltage, the external switch (13) is connected to the power supply voltage (36.4(b))
(c) the measured voltage is in a range near the 0 volt mark, the external switch is connected to ground (36.4 (c))

41 Procedure according to claims 33 to 37 which is defined by the following characteristics:
41.1 the interface (2) is configured as an output
41.2 the on/off switch (1) is a low-side switch
41.3 the on/off switch (1) is open
41.4 using the voltage measured at the second interface (6), four different statuses of the electronic circuit can be determined:
(a) the measured voltage is in a range around the open circuit voltage, the circuit at the interface (2) is interrupted or there is no load connected (37.4(a))
(b) the measured voltage is in a range near the 0 volt mark, there is a short circuit to ground from the interface (2) (37.4 (b))
(c) the measured voltage is in the range near the power supply voltage, there is a short circuit to the power supply (37.4(c))
(d) the measured voltage is in the range above the around the open circuit voltage range and below the voltage of the power supply, there is a load on the power supply (37.4(d))

42. Procedure according to claims 33 to 37 which is defined by the following characteristics:
42.1 the interface (2) is configured as an output
42.2 the on/off switch (1) is a low-side switch
42.3 the on/off switch (1) is closed
42.4 using the voltage measured at the second interface (6), four different statuses of the electronic circuit can be determined:
(a) the measured voltage is in a range near the 0 voltage, the circuit is working properly
(b) the measured voltage is in a range around the open circuit voltage, there is a fault in the circuit, especially there is a short circuit to an external voltage or a defective on/off switch (1)
(c) the measured voltage is in the range near the power supply voltage, there is a short circuit to the power supply on the interface (2)

43 Procedure according to claims 35 to 37 which is defined by the following characteristics:
43.1 the interface (2) is configured as an input
43.2 the on/off switch (1) is a low side switch
43.3 the on/off switch (1) is open
43.4 using the voltage measured at the second interface (6), four different statuses of the electronic circuit can be determined:
(a) the measured voltage is in a range around the open circuit voltage, the circuit at the interface (2) is interrupted especially through an external open switch (36.4(a))
(b) the measured voltage is in the range near the power supply voltage, the external switch (13) is connected to the power supply voltage
(c) the measured voltage is in a range near the 0 volt mark, the external switch (13) is connected to ground.

44 Procedure according to claims 33 to 43 which is defined such that when a fault is detected on the faulty or endangered component, in particular the on/off switch (1), is deactivated.

45 Procedure according to claims 33 to 44 which is defined such that when a fault is detected, an alarm signal is output, acoustic and/or optical.

46 Procedure according to claims 33 to 45 which is defined such that when a fault is detected, the endangered component is deactivated.

47 Procedure according to claims 33 to 46 which is defined such that when a fault is detected, an entry is recorded in the fault memory.

48 Procedure according to claims 33 to 47 which is defined such that the voltage of the power supply is measured.

49 Procedure according to claims 33 to 48 which is defined such that the measured voltage of the power supply is used as a reference value during the division of the voltage ranges.
